(19) United States
(12) Patent Application Publication
(10) Pub. No.: US 2013/0332962 A1
(43) Pub. Date: Dec. 12, 2013

(54) ELECTRONICALLY COMMUNICATING MEDIA RECOMMENDATIONS RESPONSIVE TO PREFERENCES FOR AN ELECTRONIC TERMINAL

(71) Applicants: Simon Moritz, Stockholm (SE); Rickard Cöster, Hagerster (SE); Cristian Norlin, Stockholm (SE)

(72) Inventors: Simon Moritz, Stockholm (SE); Rickard Cöster, Hagerster (SE); Cristian Norlin, Stockholm (SE)

(73) Assignee: Telefonaktiebolaget L M Ericsson (publ), Stockholm (SE)

(21) Appl. No.: 14/001,118

(22) PCT Filed: Jan. 31, 2012
(86) PCT No.: PCT/IB2012/000140

§ 371 Date: Aug. 22, 2013

Related U.S. Application Data
(60) Provisional application No. 61/447,202, filed on Feb. 28, 2011.

(51) Int. Cl. H04N 21/482

(52) U.S. Cl. CPC H04N 21/4826
USPC 725/46

(57) ABSTRACT

An electronic terminal is disclosed that includes a communication interface, a user interface device, and a processor circuit. The communication interface communicates through a network with a media server. The processor circuit detects occurrence of a defined event, generate a request for media recommendations containing a terminal identifier for the electronic terminal responsive to the defined event, and communicates the request for media recommendations to the media server. The processor circuit also receives media recommendations from the media server responsive to the request for media recommendations, and communicates the media recommendations through the user interface device Related media servers and methods of providing media from a media server to an electronic terminal are disclosed.

### RELATED APPLICATIONS

The present application claims the benefit of priority from U.S. Provisional Application No. 61/447,202 entitled “Electronically Displaying Media Recommendations Responsive to Preferences Associated with a Video Terminal” filed Feb. 28, 2011, the disclosure of which is hereby incorporated herein in its entirety by reference.

### TECHNICAL FIELD

The present disclosure relates to media servers and related electronic terminals and, more particularly, to communicating information regarding media that is available for use on an electronic terminal.

### BACKGROUND

Electronic Program Guides (EPGs) provide users of televisions and other media applications with menus that display scheduling information for current and upcoming programming.

Non-interactive EGPs are typically broadcast on a dedicated channel which is viewable on a video terminal as a non-interactive menu of program scheduling information from a cable or satellite television service provider. EPGs are broadcast by specialized video generation equipment housed within each provider's central television distribution facility. By tuning a receiver to a dedicated EPG channel, a menu is displayed that lists current and upcoming programs on all available channels.

A more modern form of EPGs is the interactive program guide. An interactive EPG allows television viewers to navigate scheduling information menus interactively, selecting and discovering programming by time, title, channel, or genre using an input device such as a keypad, computer keyboard, or television remote control. Its interactive menus are generated entirely within a broadcast signal receiver or display equipment using program and schedule information that is received from television service providers.

Because of the increasing number of channels provided by television service providers, users must sometimes page through numerous screens of programming information provided by interactive EPGs to discover an interesting program.

### SUMMARY

If may therefore be an object to address at least some of the above mentioned disadvantages and/or to improve performance in a communication system.

Some embodiments of the present invention are directed to an electronic terminal that includes a communication interface, a display device, and a processor circuit. The communication interface communicates through a network with a media server. The processor circuit detects occurrence of a defined event, generate a request for media recommendations containing a terminal identifier for the electronic terminal responsive to the defined event, and communicates the request for media recommendations to the media server. The processor circuit also receives media recommendations from the media server responsive to the request for media recommendations, and displays the media recommendations on the display device.

Accordingly, when a defined event, such as terminal initialization, occurs, media recommendations are obtain that can be customized based on an identity of the terminal. The media recommendations can used to guide a user's selection of media for consumption through the terminal.

According to a further embodiment, terminal includes a proximity sensor that detects when the user has become proximately located to the electronic terminal and/or discovers presence of another terminal carried by the user which is now within communication range of the proximity sensor. The processor circuit responds to a signal from the proximity sensor by communicating the request for media recommendations to the media server to request media recommendations for the user. The media recommendations may thereby be automatically fetched from the media server when the user approaches the terminal.

Some other embodiments of the present invention are directed to a corresponding media server that includes a media recommendation circuit that receive a request for media recommendations containing a terminal identifier through a network from an electronic terminal, generates media recommendations responsive to the terminal identifier, and communicates the media recommendations through the network to the electronic terminal for display to a user.

Some other embodiments of the present invention are directed to a corresponding method of providing media from a media server to an electronic terminal through a network. A request for media recommendations is received at the media server. The request contains an identifier associated with the terminal. Media recommendations are generated responsive to the terminal identifier. The media recommendations are communicated through the network to the electronic terminal for display to a user. A media selection is received through the network from the electronic terminal indicating the user's selection of the media among the media recommendations. The media is provided to the electronic terminal responsive to the media selection.

Other electronic terminals, media servers, and methods according to embodiments of the invention will be or become apparent to one with skill in the art upon review of the following drawings and detailed description. It is intended that all such additional electronic terminals, media servers, and methods be included within this description, be within the scope of the present invention, and be protected by the accompanying claims. Moreover, it is intended that all embodiments disclosed herein can be implemented separately or combined in any way and/or combination.

### BRIEF DESCRIPTION OF THE DRAWINGS

The accompanying drawings are included to provide a further understanding of various embodiments of the present invention and are incorporated in and constitute a part of this application. In the drawings:

FIG. 1 is an example block diagram of a system that includes a plurality of media servers that respond to activation of an identified one of a plurality of video terminals to generate media recommendations for display on the activated video terminal, in accordance with some embodiments;

FIG. 2 is an example block diagram of one of the video terminals and the media servers of FIG. 1, which are configured according to some embodiments;

FIG. 3 is an example block diagram of the media recommendation circuit shown in FIG. 2 that is configured according to some embodiments;

FIG. 4 is another example block diagram of one of the media servers of FIG. 1;

FIG. 5 is an example data flow diagram of operations and methods that may be carried out by one or more of the video terminals and media servers of FIG. 1;

FIGS. 6 and 7 are example flowcharts of operations and methods that may be carried out by one or more of the media servers of FIG. 1;

FIGS. 8-10 are example listings of recommended TV programs, movies, and/or applications that are displayed on a display device of a video terminal in accordance with some embodiments;

FIG. 11 is an example block diagram of one of the video terminals of FIG. 1 according to some embodiments; and

FIGS. 12-14 are example flowcharts of further operations and methods that may be carried out by the one or more of the media servers of FIG. 1.

### DETAILED DESCRIPTION

The invention will now be described more fully hereinafter with reference to the accompanying drawings, in which embodiments of the invention are shown. This invention may, however, be embodied in many different forms and is not limited to the embodiments set forth herein.

Various embodiments of the present invention are directed to generating media recommendations that are displayed on video terminals, where the media recommendations can be customized for each of the video terminals based on their identities. Activation of a video terminal can trigger generation of media recommendations by a media server, and the media recommendations can be displayed on a display device of the video terminal to guide a user's media selections. Although various embodiments are described in the context of a “video terminal”, it is to be understood that the invention is not limited thereto and may be used with any type of electronic terminal that is configured to communicate with a media server to receive media recommendations.

In some embodiments, a user's consumption (e.g., viewing, downloading, executing, etc.) of media (e.g., TV programs, movies, and/or executable user applications) through a video terminal is tracked to generate user data that is associated with a video terminal identifier (which uniquely identifies the terminal). Information that may be tracked as part of the user data may include what time of day, day of week, and/or date a particular media was consumed, a title of the media, description of the media, category (e.g., genre) of the media, and/or other characteristics that are defined for the media. Other user data that may be tracked can include when a user recommends or otherwise rates a particular media to others for consumption and/or sends a link for a particular media to another user (e.g., URL hyperlinks in email messages) to facilitate consumption of the media by the other user.

When the video terminal is activated in response to, for example, being powered-on, transitioning from a standby state to an active state (e.g., waking-up from a sleep state), or a user being electronically detected as being newly located proximate to the video terminal or an associated sensor device, the identifier of the video terminal is used to look up the user data for the video terminal. The user data may be compared to metadata that characterizes media files that are available from a media server to identify media files that programmatically match the user's interests, and the identified media files can form a media recommendation that is displayed on the video terminal for selection amongst by the user. A user may then select one or more of the displayed recommendations to cause the selected media to be viewed (e.g., tune the video terminal to a defined broadcast program channel or play from local memory), downloaded from a media server (e.g., video-on-demand), executed on a media server or from local memory, etc.

Generation of the media recommendations may include a comparison of the user data (preference information) to other user data that is associated with other video terminals to identify other users who have similar perceived interests/tastes to the user of the video terminal 120, and to generate therefrom media recommendations based on the consumption history of the other users. Results of the comparison may be used to generate media recommendations that are displayed on the activated video terminal.

As used herein, a “video terminal” can be any electronic terminal that is configured to receive and display media recommendations from a media server, and to display and/or execute media that may be part of the video terminal and/or may be communicated thereto. A video terminal (electronic terminal) may include, but is not limited to, a television/display device, a television tuner (e.g., cable/satellite tuner, such as a set-top-box) that is separate but communicatively connected to a television monitor/display device, a wireless communication terminal (e.g., cellular terminal, local area network terminal, etc.), and/or a desktop/laptop/palmtop/tablet computer.

A media server can be any networked node that generates media recommendations that are sent to an electronic terminal, and may contain media that is deliverable (e.g., streamed, downloaded, etc.) to the terminal responsive to a user's selection among the media recommendations. The media server may alternatively or additionally be embodied within another electronic terminal that is configured to generate and communicate media recommendations to the terminal. The media server may still alternatively or additionally be embodied in a social media network node that provides social network services to users, such as the “Facebook” social network website and movie/television ratings websites through which users can recommend movies, TV programs, and other media to each other. Such media recommendations can be communicated to the terminal where they can be displayed according to various embodiments described herein.

As used herein, the term media can include, but is not limited to information that can be visually displayed and/or audibly generated by a terminal, such as television programs and movies, and/or that can be executed, such as executable user applications, by a terminal to generate information that is displayed and/or audibly generated by the terminal. Media may therefore include, but is not limited to, digital and/or analog signals that are received as broadcast and/or selectively downloaded signals (e.g., video-on-demand) from a television program/movie server, such as a cable media server, a terrestrial media server, satellite media server, and/or an Internet media server.

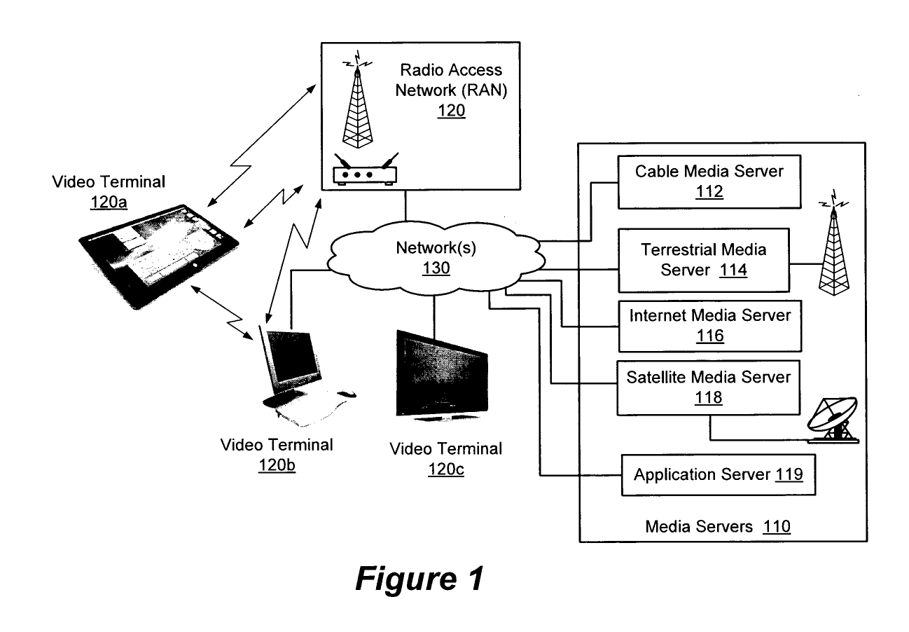

These and other embodiments are further described below with regard to FIGS. 1-14.

FIG. 1 is an example block diagram of a system that includes a plurality of wireless and/or wired video terminals 120a-c, a radio access network (RAN) 120, and a plurality of media servers 110 that are configured according to some embodiments of the present invention. The media servers 110 are configured to respond to activation of an identified one of a plurality of video terminals 120a-c by generating media recommendations that are displayed by the activated video terminal to a user. A user may select among the displayed media recommendations to cause the selected media to be viewed. The user's selection of one of the media recommendations may trigger the selected media to be downloaded from one or more of the media servers 110 (e.g., video-on-demand), trigger tuning of a broadcast media receiver to a defined broadcast program channel to receive the selected media, and/or trigger playing of the selected media from local memory of the terminal.

The media servers 110 may include a cable media server 112 (e.g., cable TV provider), a terrestrial media server 114 (e.g., terrestrial TV provider), an Internet media server 116 (e.g., video-on-demand provider), a satellite media server 118 (e.g., satellite TV provider), and/or an application server 119 that may broadcast media to all video terminals within a communication coverage area and/or stream media on-demand responsive to particular requests from identified video terminals. The cable media server 112, the Internet media server 116, and the application server 119 may communicate media to the video terminals 120a-c through one or more networks 130 (e.g., Internet or other public/private networks) and/or the RAN 120.

The RAN 120 may contain one or more cellular radio access technology systems that may include, but are not limited to, Global Standard for Mobile (GSM) communication, General Packet Radio Service (GPRS), enhanced data rates for GSM evolution (EDGE), DCS, PDC, PCS, code division multiple access (CDMA), wideband-CDMA, CDMA2000, Universal Mobile Telecommunications System (UMTS), and/or 3GPP LTE (3^{rd} Generation Partnership Project Long Term Evolution). The RAN 120 may alternatively or additional communicate with one or more of the terminal 120a-c through a Wireless Local Area Network (i.e., IEEE 802.11) interface, a Bluetooth interface, and/or other wireless communication interface.

As explained above, although some embodiments have been described in the context of a video terminal 120 receiving recommendations and media from the media server 110, other video terminals according to some embodiments are not limited thereto. At least some of the functionality that is described herein as being carried out by the media server 110 to generate media recommendations and supply selected media for a video terminal may instead be incorporated in and carried out by components of the video terminal and/or by other network nodes of the system (e.g., social media network node).

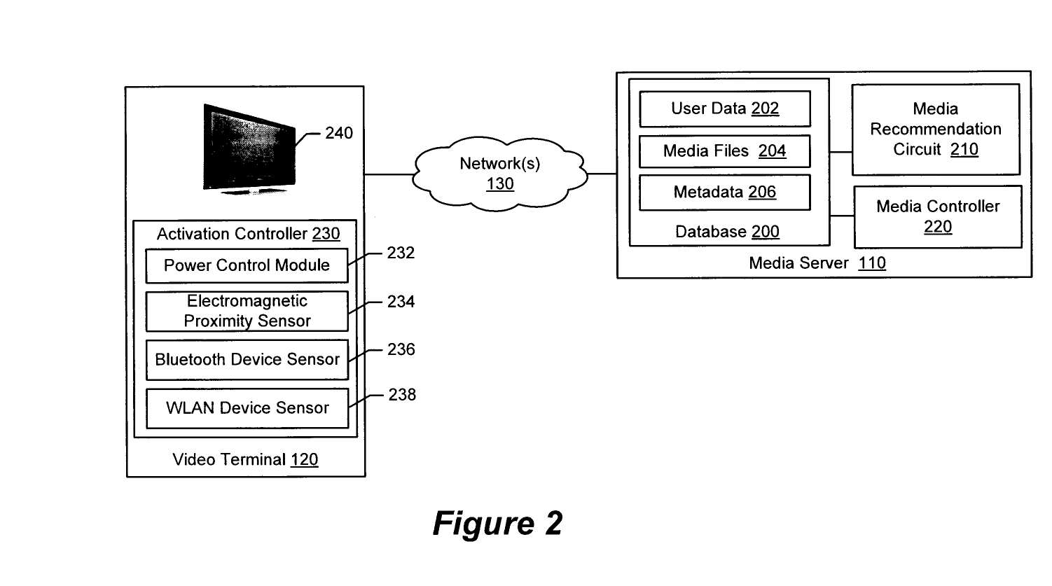

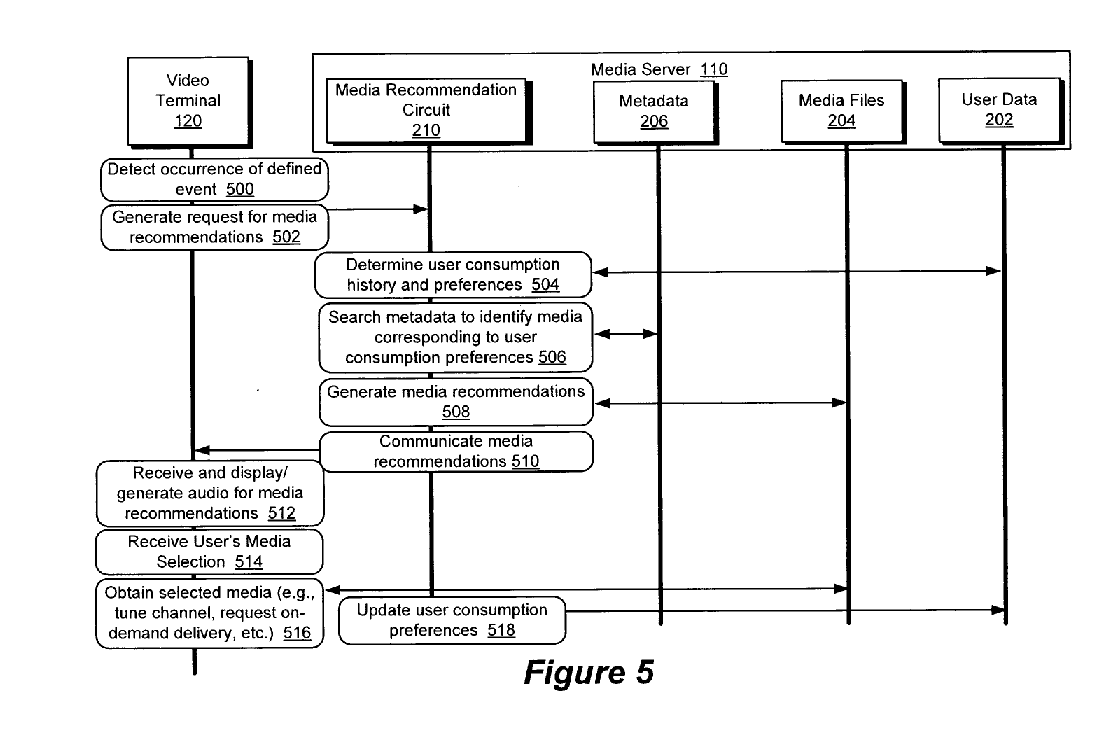

FIG. 2 is an example block diagram of one of the video terminals 120 and one of the media servers 110 of FIG. 1. FIG. 5 is an example data flow diagram of operations and methods that may be carried out a video terminal 120 and a media server 110 of FIG. 1. Referring to FIGS. 2 and 5, the video terminal 120 detects occurrence of a defined event (block 500). The video terminal 120 responds to the defined event by generating (block 502) a request for media recommendation, where the request contains a terminal identifier for the video terminal 120 (a terminal identifier). The terminal identifier may uniquely identify the video terminal 120, and may further identify particular users who have been determined to be proximately located to the video terminal 120 and/or may identify how many users have been determined to be proximately located to the video terminal 120, as will be further explained below.

The media recommendation circuit 210 uses the identifier of the video terminal 120 to look up (block 504) user consumption history and/or preferences (e.g., user defined preferences and/or media consumption history), which can be stored in user data 202, as will be further explained below, and associated with the terminal identifier. The preference information may be compared to metadata 206 that characterizes media files 204, which may be available for download from the media server 110 or other network node, to identify media files 204 that programmatically match the user's preferences, and the identified media files 204 can be programmatically ranked based on the degree of matching (similarity) to generate a media recommendation. The media recommendation circuit 210 may generate the media recommendations by comparing any of the information contained in the user data to characteristics of the media that is available from the media server 110.

Media recommendations are generated (block 508), such as by filtering the identified media files 204 based on the ranking and defined rules. The defined rules may include constraints on how many media recommendations and/or in what format the media recommendations can be displayed on the identified video terminal 120. The media recommendations are communicated (block 510) to the video terminal 120 for display on the display device 240. The video terminal 120 receives and displays and/or generates audio output (block 512) to electronically communicate the media recommendations to a user. A user's selection of one or more of the displayed media recommendations is received (block 514), such as through a touch display interface and/or other user input interface. The video terminal 120 causes the selected media to be obtained (block 516), such as by tuning a receiver of the video terminal 120 to a defined broadcast program channel, by communicating a command to the media server 110 to download the selected media (e.g., video-on-demand), by executing the selected media on the media server 110, and/or by accessing the media in a local memory of the video terminal 120, etc.

The media recommendation circuit 210 may update (518) data that identifies the user consumption preferences to reflect the user's selection of the identified media. For example, the media recommendation circuit 210 may store the updated data in the user data 202 in the database 200.

Various example events that may be defined to trigger communication of a request for media recommendations from the video terminal 120 to the media server 110 will be explained. The video terminal 120 can include an activation controller 230 that detects occurrence of the defined event and responsively generates an activation signal to trigger communication of a request for media recommendations to the media server 110. In one embodiment, the defined event is activation of the video terminal 120. The activation controller 230 can include a power control module 232 that detects activation of the video terminal 120 in response to regulation of a power/stand-by state of the terminal 120, which can be triggered by a user command to turn on power to the display device 240 and/or to transition from a stand-by state to an active state (e.g., actuation of a power button, occurrence of a scheduled event, a command from a remote control, etc.).

In some other embodiments, detection of the defined event can be performed by a sensor that electronically detects when a user has become proximately located to the video terminal 120 or an associated device. The sensor may, for example, be an electromagnetic proximity sensor 234 that uses electromagnetic signals (e.g., infrared, radio frequency signals, or other signals) to detect the presence of a user. The sensor may alternatively be a Bluetooth device sensor 236 and/or WLAN device sensor 238 that is configured to discover presence of a terminal carried by a user, via Bluetooth signaling or WLAN signaling, that is now within communication range of the sensor. The sensors 236/238 may further use received signal strength or another ranging technique to determine whether a terminal carried by the user is within a defined range of the terminal 120 to detect occurrence of the defined event. Accordingly, when a user becomes proximately located to the terminal 120, a sensor can detect the user's presence directly through a proximity sensor or by indirectly detect the presence by sensing Bluetooth/WLAN circuitry of a terminal that is carried by the user.

Moreover, the activation controller 230 may identify how many users and which particular users are proximately located to the video terminal 120 by receiving user login information and/or other user information that is entered into the terminal 120, and/or by uniquely identifying the wireless terminal(s) carried by the user(s) through Bluetooth signaling via the sensor 236, WLAN signaling via the sensor 238, and/or other signaling carried out between the activation controller 230 and electronic circuitry within the user carried wireless terminals. The activation controller 230 may therefore further include as part of the video terminal identifier, an identifier for particular users that have been sensed as being proximately located to the video terminal and/or an indication of how many users are located proximately located.

The terminal 120 may therefore request media recommendations that are customized to which particular user is presently using the terminal 120. The terminal 120 can be configured to identify a present user from among a plurality of defined users who are known to the terminal 120. The terminal 120 can generate the request for media recommendations to contain a user identifier for the present user, so that the media server 110 can generate the media recommendations to be customized in response to the user identifier for the present user.

The terminal 120 may request media recommendations that are customized to a number of present users (e.g., so that different media can be recommended when the selected media will be viewed by one user versus a group of users). The terminal 120 can be configured to identify how many users are presently using the electronic terminal 120. The terminal 120 can generate the request for media recommendations to contain a user identifier user information identifying how many users are presently using the terminal 120, so that the media server 110 can generate the media recommendations to be customized in response to the number of users.

As explained above, the media server 110 may include the database 200, the media recommendation circuit 210, and the media controller 220. The database 200 may include user data 202, media files 204, and metadata 206. The user data 202 provides a historical accounting of what media a user has consumed through the video terminal 120.

The metadata 206 identifies characteristics of the media files 204, such as visual/audible content of the respective media files 204. For example, the metadata 206 may include labels that categorize/characterize the visual/audible content (e.g., genre) of the media files 204, user (viewing) ratings of the media files 204, content ratings (e.g., G-rating, PG-rating, PG-13-rating, R-rating, etc.) of the media files 204, violence ratings of the media files 204, and/or language ratings of the media files 204.

The media server 110 may receive user ratings directly from a user (e.g., via a network) and/or may receive the user ratings indirectly through another network node (e.g., a social network node, etc.), and store the user ratings in the user data 202 and/or the metadata 206 associated with the corresponding terminal identifier. The user ratings may indicate the user's opinion (recommendation) about the media by, for example, indicating how many points out of a defined point scale a user liked/disliked the media (e.g., selecting a number out of a define number scale, selecting a number of stars out of a defined star scale, selecting “thumbs up” or “thumbs down”, etc.).

The user data may identify a geographic location of the video terminal 120, such a registered home location of the user and/or a present location of the video terminal 120.

The media server 110 (via the media recommendation circuit 210) or another network node may alternatively or additionally implicitly determine user ratings for media in response to observing the user's actions when consuming the media at the video terminal 120 and/or at another terminal. For example, the media recommendation circuit 210 can be configured to implicitly determine the user's rating for a media in response to tracking: 1) how many times the user's consumed (e.g., viewed) the media (e.g., increasing a user's implicit rating responsive to the user watching a movie an increasing number times); 2) how much of the media the user consumed (e.g., indicate a higher rating responsive to the user watching an entire movie, indicate a lower rating responsive to the user watching less of the movie, or increase a user's implicit rating responsive to the user watching more of a movie); 3) whether the user locally saved the downloaded application/TV program/movie for future use; 4) whether the user viewed information/descriptions (e.g., metadata) associated with the media (e.g., description of a movie, a “making of the movie” or “additional scenes not present in the feature length movie”, etc.). The media recommendation circuit 210 can generate the media recommendations responsive to the generated ratings.

The media server 110 (via the media recommendation circuit 210) can alternatively or additionally be configured to implicitly determine the user's rating for a media in response to tracking: 1) which of the media have been recommended by one or more users for consumption by one or more other users; 2) tracking which of the media have been added by a user to a preferred list that is accessible by one or more other users to provide earlier accessibility to the media by the other users; 3) which of the media are referenced by links that users have sent to other users to provide easier accessibility to the media by the other users; 4) whether the user requested (e.g., searched for) other applications that have similar characteristics to a media; and/or 5) whether the user deleted/uninstalled the media from local storage of the video terminal. The media recommendation circuit 210 can generate the media recommendations responsive to the generated ratings.

The metadata 206 may identify other characteristics of the media files 204, such as the play time of the media files 204. Although the metadata 206 has been illustrated in FIG. 2 as being separate from the media files 204, it is not limited thereto and may instead be at least partially embedded within the media files 204.

The media recommendation circuit 210 is configured to generate media recommendations that can be customized for each of the video terminals 120a-c based on an identity of the video terminal and the user data associated with that terminal identity. The media controller 220 may be configured to broadcast or stream media to one or more of the video terminals 120a-c. For example, when a user selects one of the media recommendations that are generated by the media recommendation server 210 and displayed on the video terminal 120, the media controller 220 may respond by streaming the corresponding selected media to the video terminal 120.

In some embodiments, the media recommendation circuit 210 is configured to send the media recommendations directly to the video terminals, or indirectly via another network node. For example, in some embodiments, the media recommendations may be posted on a social media website (e.g., “Facebook” social network website) in an account associated with a video terminal (e.g., user) having a particular terminal identifier. The media recommendations may alternative or additionally be sent to a particular video terminal by email, data message (e.g., Short Message Service and/or Multimedia Messaging Service), or other communication signaling.

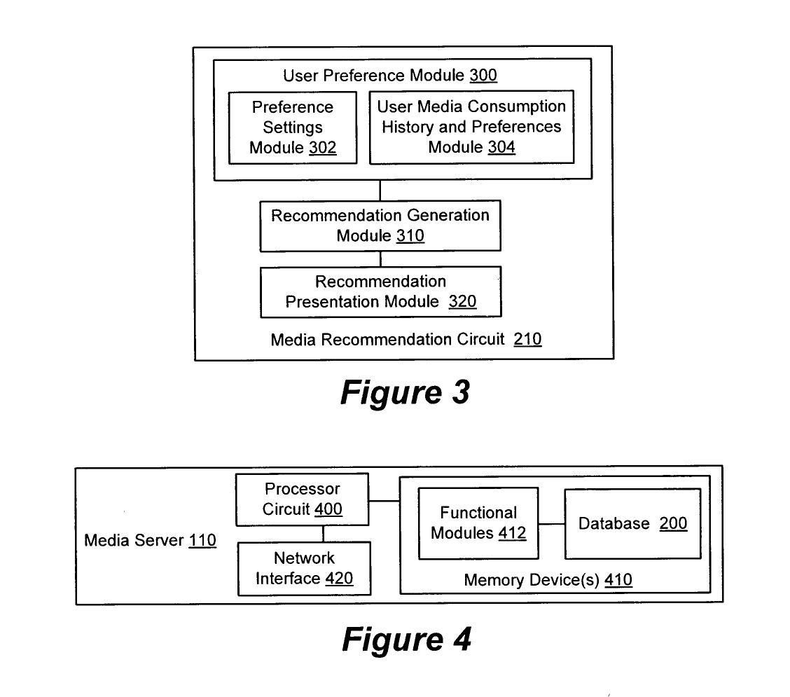

FIG. 3 is an example block diagram of the media recommendation circuit 210 shown in FIG. 2. Referring to FIG. 3, the media recommendation circuit 210 may include a user preference module 300, a recommendation generation module 310, and a recommendation presentation module 320. The user preference module 300 may include a preference settings module 302 that stores and retrieves user defined media preferences (e.g., genres, television/movie categories/titles, content ratings (e.g., G-rating, PG-rating, PG-13-rating, R-rating, etc.)) that is associated with (linked to) an identifier of the video terminal within the user data 202 (FIG. 2).

The user preference module 300 may include a consumption history module 304 that tracks the consumption (e.g., viewing, downloading, executing, etc.) of media through a video terminal having a defined identifier. The consumption history module 304 may additionally or alternatively track what time of day, day of week, and/or date a particular media was consumed, a title of the media, description of the media, category (e.g., genre) of the media, how often a particular media was selected, and/or other characteristics that are defined for the media. For example, the module 304 may determine and record in the user data 202, associated with the video terminal identifier, that a user prefers a particular television program, prefers a group of television program, and/or prefers a particular genre or other characteristics (e.g., run-time duration) of television programs at certain times of day.

The consumption history module 304 may additionally or alternatively track when a user recommends or otherwise rates a particular media to others for consumption and/or sends a link for a particular media to another user (e.g., URL hyperlinks in email messages) to facilitate consumption of the media by the other user. The consumption history module 304 is configured to store and retrieve the tracked information that is associated with (linked to) an identifier of the video terminal within the user data 202 (FIG. 2).

The recommendation generation module 310 is configured to respond to receipt of an identifier for the video terminal 120 by generating media recommendations based on the defined/observed preferences of a user of the video terminal 120. The module 310 may use the identifier of the video terminal 120 to look up preference information (e.g., user defined preferences and/or media consumption history) within the user data 202 for the particular media terminal 120. The preference information may be compared to the metadata 206 that characterizes the media files 204 that are available from the media server 110 to identify media files 204 that programmatically match the user's interests, and the identified media files 20 can be ranked based on the degree of programmatic matching (similarity) to generate a media recommendation.

Generation of the media recommendations may include performing a comparison of the preference information to other user data 202 that is associated with other video terminals to identify other users who have similar perceived interests/tastes to user of the video terminal 120, and to generate therefrom media recommendations based on the consumption history of the other users. The media recommendations may alternatively or additionally include a comparison of the video terminal's 120 geographic location (e.g., registered home location and/or present terminal location) to the consumption history of other users who have a similar geographic location to the video terminal 120, such as by being within a defined distance of the video terminal 120 and/or by being within the same city, county, state, and/or country as the video terminal 120. Accordingly, when the video terminal 120 has a registered home location or a present location in Germany, the terminal 120 may then be provided with media recommendations based on the consumption histories of other users who are located in Germany, which can thereby allow cultural and language based customization of the media recommendations that are generated by the recommendation generation module 310 and sent to the video terminal 120.

In another example embodiment, the recommendation generation module 310 may determine from the user data 202, using the identifier for the video terminal 120, that the user prefers to watch comedy movies having certain characteristics at the present time and day of week. The module 310 may compare these characteristics of the user to those of other users identified in the user data 202 who have similar viewing interests and who have watched a defined group of movies that the user of the video terminal 120 has not yet watched. The generation module 310 may generate a list of recommended movies that includes the defined group of movies (watched by others having similar identified interests), and communicate that list to the video terminal 120, via the recommendation presentation module 320, for display to the user.

The recommendation presentation module 320 may filter the identified media files 204 based on the ranking and defined rules (e.g., constraints on how many media recommendations and/or in what format the media recommendations can be displayed on the video terminal 120) and communicate the media recommendations to the video terminal 120 for display on the display device 240. A user may then select one or more of the displayed recommendations to cause the selected media to be consumed, such as by being viewed (e.g., tune the video terminal 120 to a defined broadcast program channel or play from local memory of the video terminal 120), downloaded from the media server 110 (e.g., video-on-demand), executed on the media server 110, etc.

FIG. 4 is another example block diagram of the media server 110. The media server 110 can include memory device(s) 410, a processor circuit 400, and a network interface 420. The memory device(s) 410 may include mass storage devices, such as one or more disk drives and/or semiconductor memory, that contain the database 200. Part of the database 200 may be omitted in some embodiments, such as when the media is received from another network node (e.g., from a separate media server). The processor circuit 400 may include one or more data processing circuits, such as a general purpose and/or special purpose processor (e.g., microprocessor and/or digital signal processor) with on-board and/or separate memory devices. The processor 400 is configured to execute computer program instructions in functional modules 412 within a memory, which is described below as a computer readable medium and which may reside within the memory device(s) 410, to operate as described herein. The network interface 420 is configured to communicate with the video terminal 120 through the network 130.

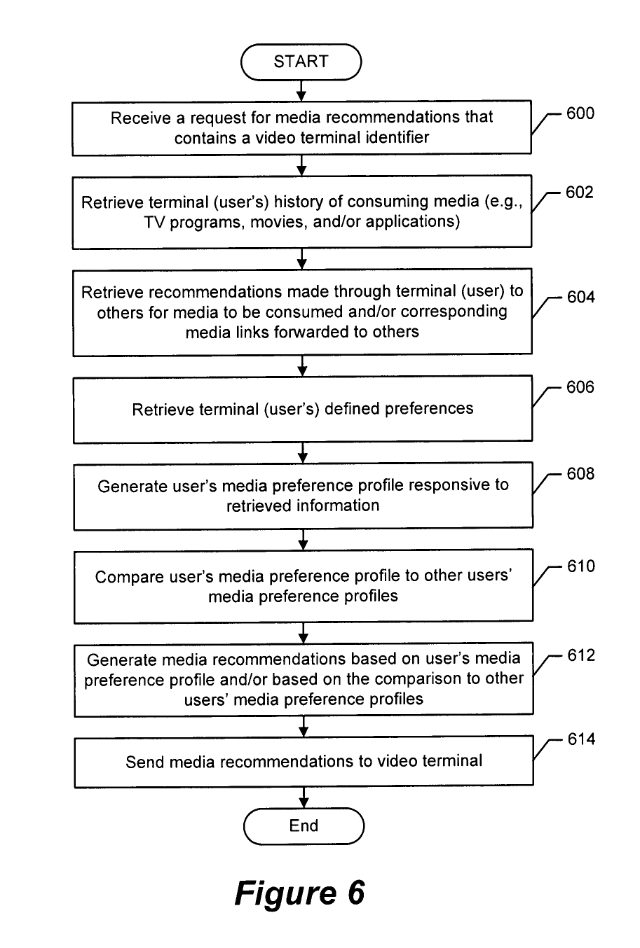

FIG. 6 is an example flowchart of operations and methods that may be carried out by one or more of the media servers 110 of FIG. 1 to generate media recommendations for a particular video terminal. Referring to FIG. 6, the media server 110 receives (block 600) a request for media recommendations through the network 130 from the terminal 120. The request contains a terminal identifier. A video terminal (user's) media consumption history may be retrieved (block 602) using the terminal identifier. The terminal identifier may be used to retrieve recommendations or other ratings that the user has made to other users (e.g., explicit and/or implicit ratings as described above) regarding particular media and/or links (e.g., URL hyperlinks in email messages) that the user has sent to others for a particular media can be retrieved (block 604). The terminal identifier may alternatively or additionally be used to retrieve (block 606) media preferences that have been defined by the user. A media preference profile is generated (block 608) for the user in response to the retrieved information. The generated media preference profile may be compared (block 610) to other users' media preference profiles to identify other users who have similar perceived interests/tastes to user of the video terminal 120. Media recommendations can be generated (block 614) based on the generated media preference profile and/or based on the comparisons other users' media preference profiles. The media recommendations are communicated (block 614) to the video terminal 120 that communicated (block 600) the identifier.

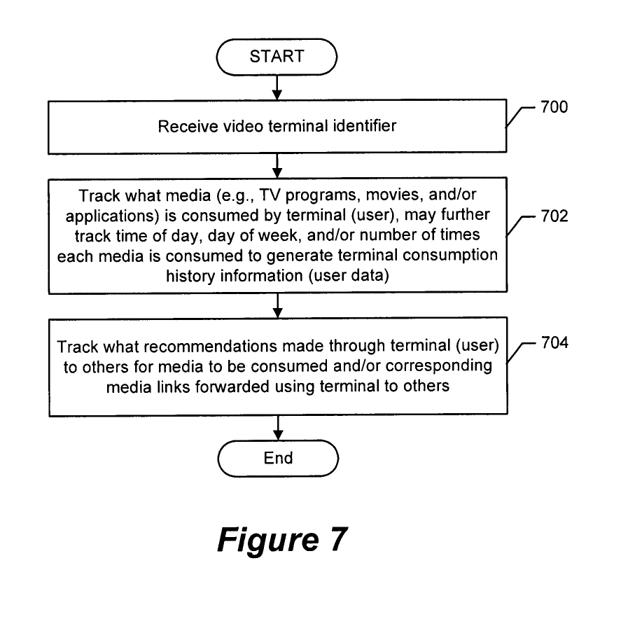

FIG. 7 is an example flowchart of other operations and methods that may be carried out by one or more of the media servers 110 of FIG. 1 to track the media consumption preferences of a user operating a particular video terminal 120. Referring to FIG. 7, information is received (block 700) that includes a video terminal identifier and further identifies media that has been consumed by the identifier video terminal. Information is recorded that tracks (block 702) what media (e.g. TV programs, movies, and/or applications) is consumed by the identified terminal, and may further track the time of day, day of week, and/or number of times each media is consumed to generate media preference information that may be stored in the user data 202 of the database 200 shown in FIG. 2. Alternatively or additionally, information may be recorded that tracks (block 704) what recommendations or other ratings that the user has made to other users regarding particular media and/or links (e.g., URL hyperlinks in email messages) that the user has sent to others for a particular media to generate media preference information that may be stored in the user data 202 of the database 200 shown in FIG. 2.

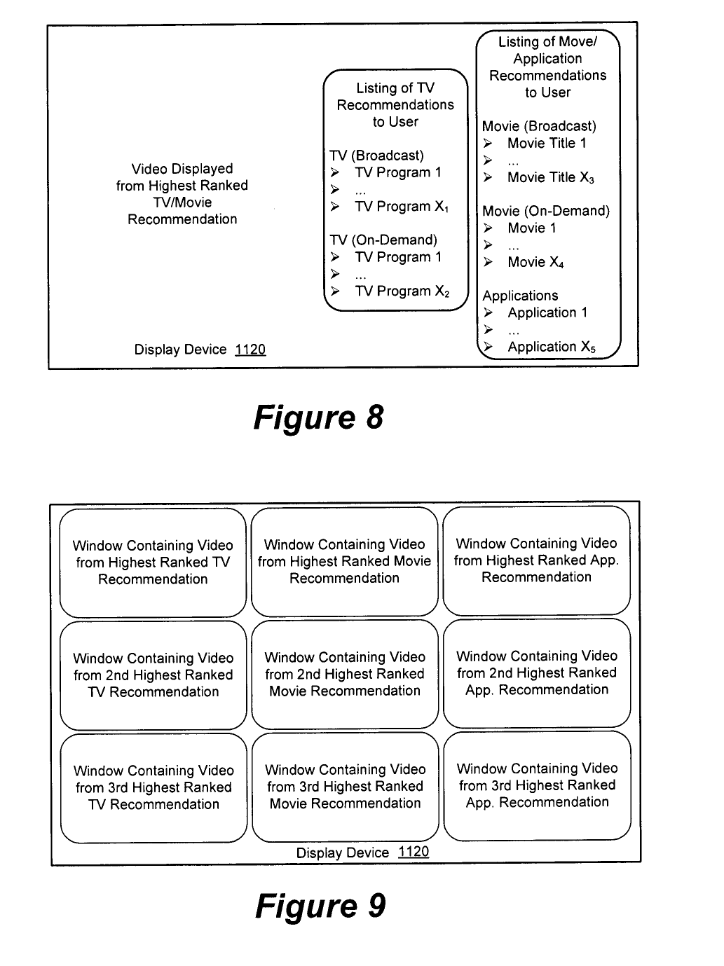

FIGS. 8-10 are example listings of recommended TV programs, movies, and/or applications that are displayed on a display device and/or output through another user output interface 1120 (e.g., speaker, display, audio output circuitry, etc) of a video terminal 120 in accordance with some embodiments.

Referring to FIG. 8, media recommendations that have been generated by a media server 110, based on defined/observed preferences for an identified video terminal 120, are displayed on a portion of the display device 1120 and/or output through another user output interface (e.g., speaker, display, audio output circuitry, etc). In the illustrated example, a list of recommended TV programs that are presently being broadcast on separate channels is displayed (e.g., TV Program 1 . . . TV Program X₁), and a list of recommended TV programs that are available for download on-demand is displayed (e.g., TV Program 1 . . . TV Program X₂). Another list of recommended movies that are presently being broadcast on separate channels is displayed (e.g., Movie Title 1 . . . Movie Title X₃), and a list of recommended movie that are available for download on-demand is displayed (e.g., Movie Title 1 . . . Movie Title X₄). Another list of recommended applications that are available for download on-demand and execution by the video terminal 120 is displayed (e.g., Application 1 . . . Application X₅).

In one embodiment, the display device 1120 may also display video from a TV program and/or movie that was highest ranked (or ranked at another defined level) among the recommendations from the media server 110. For example, as shown in FIG. 8, the lists of recommended media may be displayed as an overlay on the video from the highest ranked TV program/movie.

A user may select one of the listed TV programs, movies, or applications to cause the selection to be played, and may replace the presently playing video in the larger portion of the display 1120.

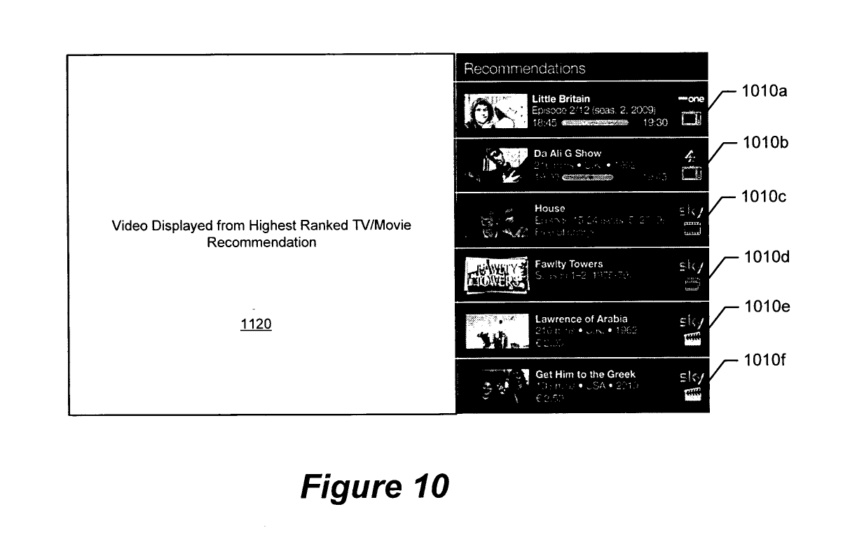

FIG. 10 is another embodiment that illustrates how media recommendations from a media server 110 can be presented on a display device 1120 of a video terminal 120. A plurality of recommended TV programs and movies 1010a-f have been displayed with their names/titles, descriptions (e.g., episode number, season reference, channel/station identifier, premium access cost to download on-demand, etc), duration, and remaining play time (for TV programs/movies that are already being broadcast). The media recommendations are displayed on one portion of the display device 1000, while another portion of the display device 1120 is used to play video from a TV program and/or movie that was highest ranked (or ranked at another defined level) among the recommendations from the media server.

FIG. 9 is another embodiment that illustrates how media recommendation can be presented on a display device 1120 of a video terminal 120. In the embodiment of FIG. 9, the media recommendations are organized into a mosaic of sub-windows. Some of the sub-windows display a defined number of top ranked TV recommendations. Similarly, some other sub-windows display a defined number of top-ranked movie recommendations, and yet other sub-windows display a defined number of top-ranked applications that can be downloaded to the video terminal 120. A user may select one or more of the sub-windows to cause the associated TV programs, movies, or applications to be consumed (e.g., played, downloaded, executed, etc.) by the video terminal 120.

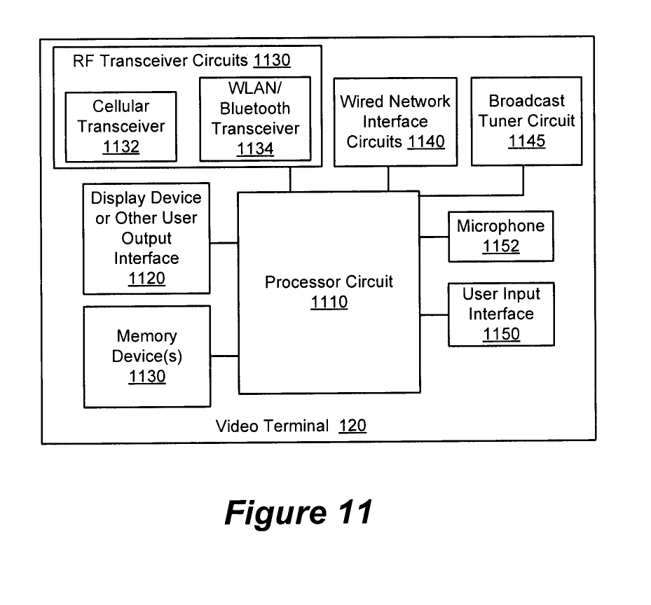

FIG. 11 is an example block diagram of one of the video terminals 120a-c of FIG. 1. The video terminal 120 can include a computer/processor circuit 1110, a display or other user output interface device 1120 (e.g., speaker, display, audio output circuitry, etc), and communication circuits, such as RF transceiver circuits 1130, wired network interface circuits 1140 (e.g., digital cable and/or digital subscriber line interface circuits), and/or a broadcast tuner circuit 1145 (e.g., digital television tuner, radio tuner, etc.). The RF transceiver circuits 1130 may include a cellular transceiver 1132 and/or a WLAN/Bluetooth transceiver 1134. The cellular transceiver 1132 may operate according to a cellular radio access technology that may include, but is not limited to, GSM, GPRS, EDGE, DCS, PDC, PCS, CDMA, wideband-CDMA, CDMA2000, UMTS, and/or 3GPP LTE.

The RF transceiver circuits 1130 may be configured to receive a media, such as streaming video and/or executable program applications, from the media server 110 via the network(s) 130 and the RAN 120 shown in FIG. 1. The wired network interface circuits 1140 may be configured to receive media from the media server 110 through the network(s) 130. The tuner circuit 1145 may be configured to be tunable to receive a channel being broadcast from the terrestrial broadcast video server 114 and/or from the satellite broadcast video server 118. The display device 1120 may be configured to display one or more video streams, such as by the methods and operations described herein. The computer/processor circuit 1110 may include one or more data processing circuits, such as a general purpose and/or special purpose processor (e.g., microprocessor and/or digital signal processor) with on-board and/or separate memory devices. The computer/processor circuit 1110 is configured to execute computer program instructions from a memory device(s) 1130, described below as a computer readable medium, to operate according to one or more embodiments disclosed herein for the video terminals. When the video terminal 120 is configured to generate the media recommendations, the memory 1130 may include all or a portion of the database 200 and the processor 1110 is configured to perform the operations and methods described above for the media recommendation circuit 210 and the media controller 220.

The video terminal 120 may further include a microphone 1152, a user input interface 1150 (e.g., touch sensitive interface associate with the display device 1120, a keypad, a keyboard, buttons, joystick, or other apparatus configured to sense user inputted commands).

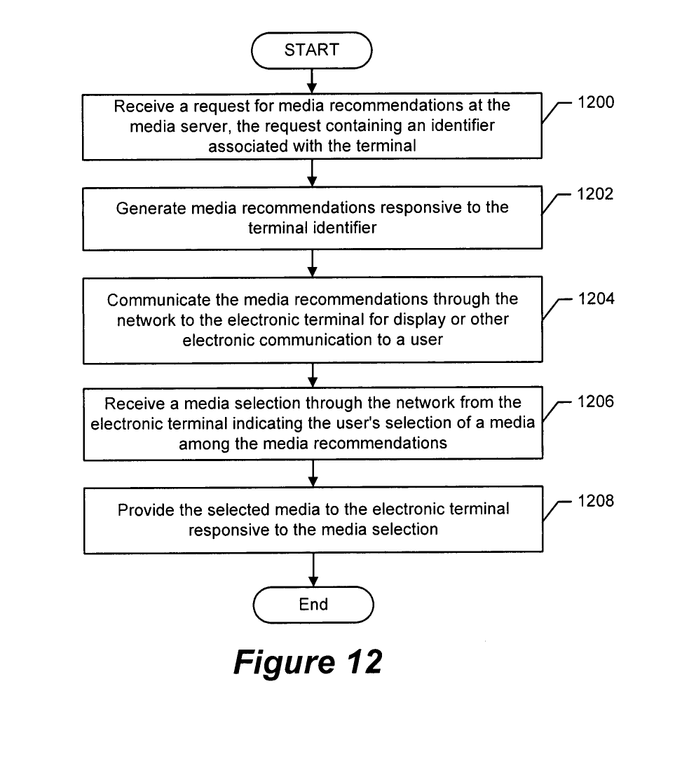

FIGS. 12-14 are example flowcharts of further operations and methods that generate media recommendations for a terminal (e.g., video terminal). of FIG. 1. The operations and methods may be carried out by one or more of the media servers 110, by one or more of the video terminals 120a-c, by another electronic terminal, and/or by another network node.

Referring to FIG. 12, example operations and methods are illustrated for providing media recommendations to a terminal that can be customized based on an identity of the terminal. A request for media recommendations is received (block 1200). The request contains an identifier for a terminal 120 that is to receive the media recommendations. The media recommendations are generated (block 1202) responsive to the terminal identifier. The media recommendations are communicated (block 1204) to the terminal for display to a user. A media selection (e.g., a command message) is received (block 1206) from the terminal which indicates a user's selection of a media among the media recommendations. The selected media is caused to be provided (1208) to the terminal responsive to the media selection. Although some embodiments are described in the context of the selected media being provide from the same server 110 that generated the media recommendations, the invention is not limited thereto. Instead, the media recommendations may be generated by an entirely different device than the device that provide the selected media to the terminal. Accordingly, in one embodiment, a first media server may generate media recommendations and receive the media selection, and then cause a second media server to provide the selected media to the terminal. In another embodiment, the first media server may generate media recommendations, and the second media server may receive the media selection and provide the selected media to the terminal.

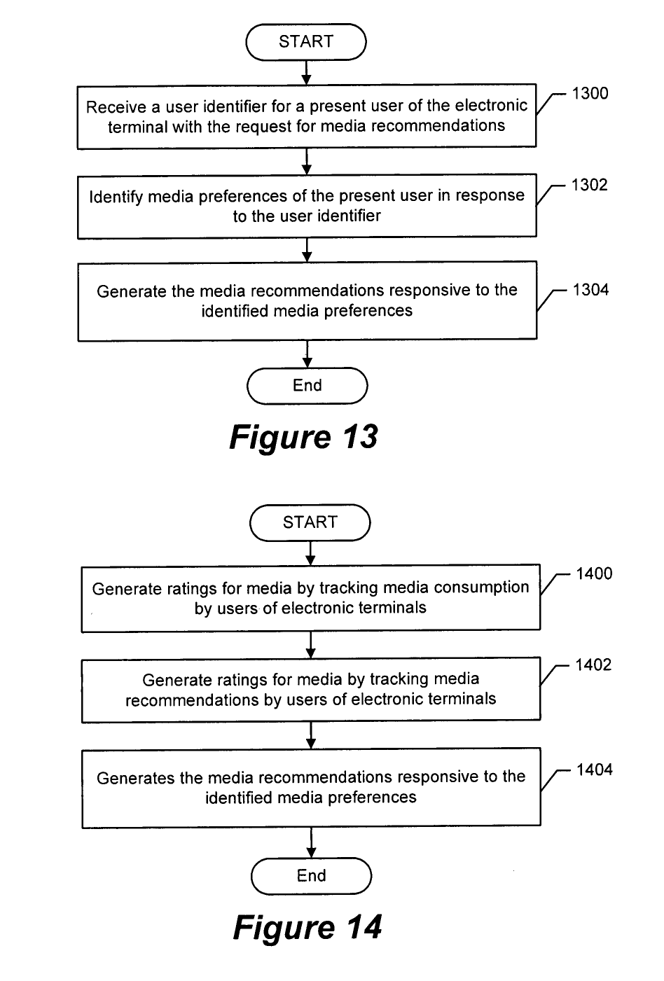

Referring to FIG. 13, example operations and methods are illustrated for providing media recommendations to a terminal that can be customized based on an identity of a present user of the terminal. A request for media recommendations is received (block 1300). The request contains a user identifier that identifies a present user of the terminal. Media preferences of the present user are identified (block 1302) in response to the user identifier. Media recommendations are generated (block 1304) responsive to the identified media preferences. The media recommendations can be displayed to the user at the terminal and/or communicated to another network node.

Referring to FIG. 14, example operations and methods are illustrated for generating media ratings that are used to make media recommendations to a user. Ratings can be generated (block 1400) for media by tracking media consumption by users of one or more terminals, which may use one or more of the consumption based ratings processes described above. Ratings may additionally or alternatively be generated (block 1402) for media by tracking media recommendations by users of one or more terminals, which may use one or more of the user recommendation based ratings processes described above. Media recommendations are then generated (block 1404) responsive to the identified media preferences. The media recommendations can be displayed to the user at the terminal and/or communicated to another network node.

In the above-description of various embodiments of the present invention, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Exemplary embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks.

Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various exemplary combinations and subcombinations of embodiments and of the manner and process of making and using them, and shall support claims to any such combination or subcombination.

Many variations and modifications can be made to the embodiments without substantially departing from the principles of the present invention. All such variations and modifications are intended to be included herein within the scope of the present invention.

1. An electronic terminal comprising:
a communication interface configured to communicate through a network with a media server
a user interface device; and
a processor circuit configured to:
detect occurrence of an activation of the electronic terminal;
generate a request for media recommendations containing a terminal identifier for the electronic terminal responsive to the activation of the electronic terminal;
communicate the request for media recommendations to the media server;
receive media recommendations from the media server responsive to the request for media recommendations; and
communicate the media recommendations through the user interface device.

2. The electronic terminal of claim 1, wherein:
a processor circuit is further configured to:
receive a user's media selection among the media recommendations;
communicate a media request that identifies the media selection to the media server; and
receive the selected media from the media server responsive to the media request.

3. (canceled)

4. The electronic terminal of claim 1, further comprising:
a proximity sensor that detects when the user has become proximately located to the electronic terminal and/or to discover presence of another terminal carried by the user which is now within communication range of the proximity sensor, as being the defined event; and
the processor circuit responds to a signal from the proximity sensor by communicating the request for media recommendations to the media server to request media recommendations for the user.

5. The electronic terminal of claim 1, wherein:
the processor circuit is further configured to:
identify a present user of the electronic terminal from among a plurality of defined users; and
generate the request for media recommendations containing a user identifier for the present user,
wherein the media recommendations received from the media server are customized by the media server responsive to the user identifier for the present user.

6. The electronic terminal of claim 1, wherein:
the processor circuit is further configured to:
identify how many users are presently using the electronic terminal; and
generate the request for media recommendations containing user information identifying how many users are presently using the electronic terminal,
wherein the media recommendations received from the media server are customized by the media server responsive to the user information, and
wherein the media recommendation circuit receives a user identifier for a present user of the electronic terminal with the request for media recommendations, identifies media preferences of the present user in response to the user identifier, and generates the media recommendations responsive to the identified media preferences.

7. A media server comprising:
a media recommendation circuit configured to:
receive a request for media recommendations containing a terminal identifier through a network from an electronic terminal;
generate media recommendations responsive to the terminal identifier; and
communicate the media recommendations through the network to the electronic terminal for electronic communication to a user.

8. The media server of claim 7, further comprising:
a media controller configured to:
receive a media selection through the network from the electronic terminal indicating the user's selection of the media among the media recommendations; and
cause the media to be provided to the electronic terminal responsive to the media selection.

9. (canceled)

10. The media server of claim 7, wherein:
the media recommendation circuit receives user information identifying how many users are presently using the electronic terminal with the request for media recommendations, and generates the media recommendations responsive to the user information.

11. The media server of claim 7, further comprising:
a database containing:
media files that are selectively provided by the media controller to the electronic terminal responsive to the user's selection among the media recommendations;
user data providing a historical accounting of which of the media files a user has previously consumed through the electronic terminal; and
metadata identifying characteristics of the media files,
wherein the media recommendation circuit uses the terminal identifier to identify within the user data the historical accounting of which of the media files have previously been consumed through the electronic terminal, and uses the identified historical accounting and the metadata to generate the media recommendations as recommendations to the user for which of the media files are recommended for consumption through the electronic terminal.

12. The media server of claim 11, wherein:
the metadata characterizes visual and/or audible content of the media files, characterizes user ratings of the media files, characterizes content ratings of the media files, and/or identifies languages of the media files; and
the media recommendation circuit uses the terminal identifier to identify within the user data the historical accounting of which of the media files have previously been consumed through the electronic terminal, uses the metadata to characterize the media files that have previously been consumed through the electronic terminal, selects other media files that have not yet been consumed through the electronic terminal responsive to the characteristics of the media files that have previously been consumed through the electronic terminal, and generates the media recommendations responsive to the selected other media files.

13.-18. (canceled)

19. A method of providing media from a media server to an electronic terminal through a network, the method comprising:
receiving a request for media recommendations at the media server, the request containing an identifier associated with the terminal;
generating media recommendations responsive to the terminal identifier;
communicating the media recommendations through the network to the electronic terminal for electronic communication to a user;
receiving a media selection through the network from the electronic terminal indicating the user's selection of the media among the media recommendations; and
providing the media to the electronic terminal responsive to the media selection.

20. The method of claim 19, further comprising:
receiving a user identifier for a present user of the electronic terminal with the request for media recommendations;
identifying media preferences of the present user in response to the user identifier; and
generating the media recommendations responsive to the identified media preferences.

21.-22. (canceled)
